(19) United States
(12) Patent Application Publication
(10) Pub. No.: US 2026/0202360 A1
(43) Pub. Date: Jul. 16, 2026

(54) X-RAY INSPECTION SYSTEM AND METHOD OF OBJECT

(71) Applicant: Gaia Vision Inc., Suwon-shi (KR)

(72) Inventors: Huigyu PARK, Suwon-shi (KR); Jaehyeok NAM, Suwon-shi (KR); Keunho REW, Suwon-shi (KR)

(21) Appl. No.: 19/447,224

(22) Filed: Jan. 13, 2026

(30) Foreign Application Priority Data
Jan. 14, 2025 (KR) 10-2025-0005266

(51) Int. Cl. G01N 23/046; B25J 9/00; G01N 23/083

(52) U.S. Cl. CPC G01N 23/046; B25J 9/0093; G01N 23/083; G01N 2223/321; G01N 2223/3306; G01N 2223/646

(57) ABSTRACT

An inspection system for an object of the present disclosure comprises a supply unit for continuously supplying objects; a load transfer; a pusher for transferring the object from the supply unit to the load transfer; and a gripper for receiving the object from the load transfer. The load transfer comprises a plurality of storage parts and a transfer unit for delivering objects to the gripper. The gripper comprises a plurality of receiving parts and an actuator for moving the receiving parts closer to or further away from each other.

### CROSS-REFERENCE TO RELATED APPLICATION

This application claims priority from Korean Patent Application No. 10-2025-0005266 filed on Jan. 14, 2025, which is incorporated herein by reference in its entirety.

### TECHNICAL FIELD

The present disclosure relates to an inspection system for an object to be inspected. More specifically, the present disclosure relates to an inspection system capable of performing defect inspection rapidly at once by efficiently supplying a plurality of HBMs (High Bandwidth Memory).

### BACKGROUND

With the advancement of AI, conventional memories have faced difficulties in keeping up with the processing speeds required for AI operations, leading to the development and widespread use of HBM. Like other semiconductor devices, the process of inspecting HBM for defects is essential. Rather than inspecting HBM devices individually, it is more effective and faster to inspect a large quantity of HBMs simultaneously.

### PRIOR ART REFERENCE

Korean Patent No. 10-0675860 (Registration Publication Date: Jan. 30, 2007)

### SUMMARY

The objective of the present disclosure is to provide an inspection system for inspecting objects such as HBM through CT imaging, which enables capturing CT images while rotating a plurality of HBMs simultaneously while they are being held.

An inspection system for an object of the present disclosure comprises a supply unit for continuously supplying objects; a load transfer; a pusher for transferring the object from the supply unit to the load transfer; and a gripper for receiving the object from the load transfer. The load transfer comprises a plurality of storage parts and a transfer unit for delivering objects to the gripper. The gripper comprises a plurality of receiving parts and an actuator for moving the receiving parts closer to or further away from each other.

The load transfer is movable within a predetermined range to receive objects from the pusher.

An elastic member can be provided between the plurality of receiving parts.

A method for inspecting an object using the inspection system of the present disclosure comprises a step of pushing objects into the storage parts of the load transfer using the pusher; a step of moving objects from the storage parts to receiving parts of the gripper; a step of driving the actuator to move the receiving parts closer to each other; and a step of acquiring CT images by performing X-ray imaging while rotating the gripper.

According to the present disclosure, a large quantity of objects such as HBM can be inspected simultaneously, which has the effect of enabling a fast inspection speed.

### BRIEF DESCRIPTION OF THE DRAWINGS

FIG. 1 is a perspective view of the inspection system according to the present disclosure.

FIG. 2 is a perspective view showing a state in which the load transfer of the inspection system delivers an object to the gripper.

FIG. 3 is a side view of the gripper of the inspection system according to the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings.

In this specification, “A or B” is defined to mean not only selecting either A or B but also including both A and B. Additionally, the term “comprise” or “include” in this specification is intended to be inclusive, meaning that other elements may be further included in addition to the listed elements.

This specification describes only the minimum components necessary to explain the present disclosure and does not mention components unrelated to the essence of the invention. Furthermore, the description should not be interpreted in an exclusive sense that includes only the mentioned components; rather, it should be interpreted in a non-exclusive sense that may include other components not mentioned.

Expressions such as “first,” “second,” or similar terms used in this specification are used to distinguish identical or similar components from each other or to differentiate the names of components or steps constituting the present disclosure, and do not imply a specific order or plurality.

In this specification, “connection” or “coupling” is interpreted to include not only a case where two components are physically directly connected or coupled but also a case where they are indirectly connected or coupled through one or more mediating elements. Additionally, “connection” or “coupling” is defined to include cases where the boundary between two components described with different names is not physically severed and is formed integrally.

The exemplary embodiments described herein provide a general understanding of the principles of the structure, function, manufacture, and use of the device and method disclosed in this specification. One or more such embodiments are illustrated in the accompanying drawings. Those skilled in the art will understand that the devices and methods specifically described herein and illustrated in the accompanying drawings are non-limiting exemplary embodiments, and the scope of the present disclosure is defined by the claims. Features illustrated and described in connection with one exemplary embodiment may be combined with features of other embodiments. Such modifications or variations are intended to be included within the scope of the present disclosure.

The “object to be inspected” in this specification may be HBM (High Bandwidth Memory), but it is not necessarily limited to HBM and can be any object that can be inspected for defects by acquiring CT images while rotating a plurality of objects at once.

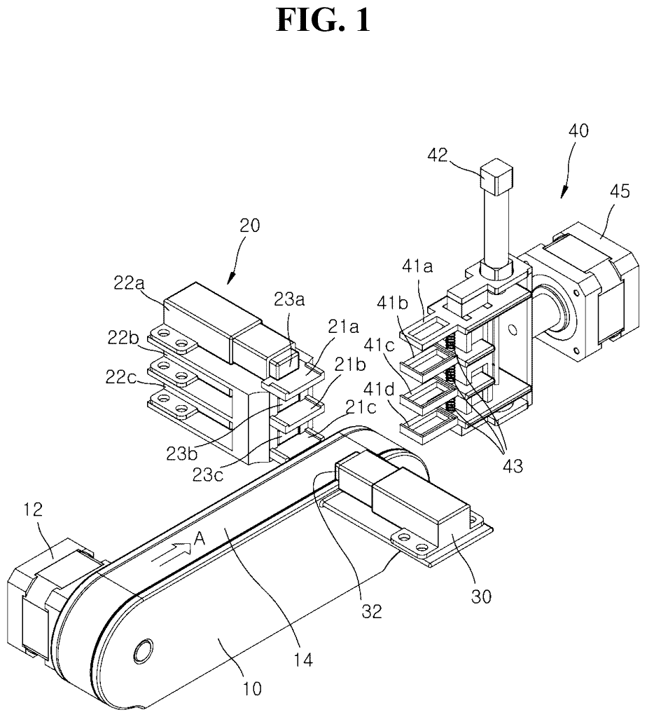

FIG. 1 shows a perspective view of the inspection system for an object to be inspected according to the present disclosure.

The inspection system according to the present disclosure comprises a supply unit (10) for the object, a load transfer (20), a pusher (30) that transfers the object disposed on the supply unit (10) to the load transfer (20) at a predetermined position, and a gripper (40) that receives the object from the load transfer (20).

The supply unit (10) may be implemented as, for example, a conveyor belt (14), but other known devices capable of supplying objects may also be used. In the exemplary embodiment shown in FIG. 1, an object (not shown) placed on the conveyor belt (14) can be continuously supplied along direction A by the operation of a motor (12).

A pusher (30) is provided on one side of the supply unit (10), and a load transfer (20) is disposed on the opposite side. The pusher (30) is provided with a push member (32) capable of advancing and retreating with respect to the load transfer (20) side by the operation of a driving means (not shown).

The load transfer (20) comprises a plurality of object storage parts (21a to 21c), and transfer units (22a to 22c) that operate to deliver the objects disposed in each storage part to the gripper (40). The transfer units (22a to 22c) are provided with push members (23a to 23c) capable of advancing and retreating to move the objects stored in the storage parts to receiving parts (41b to 41d) of the gripper (40), which will be described later. The push members (23a to 23c) advance and retreat by a driving means (not shown) provided in the transfer unit.

The load transfer (20) may be provided to move up and down along the height direction of the supply unit (10) by a driving means (not shown).

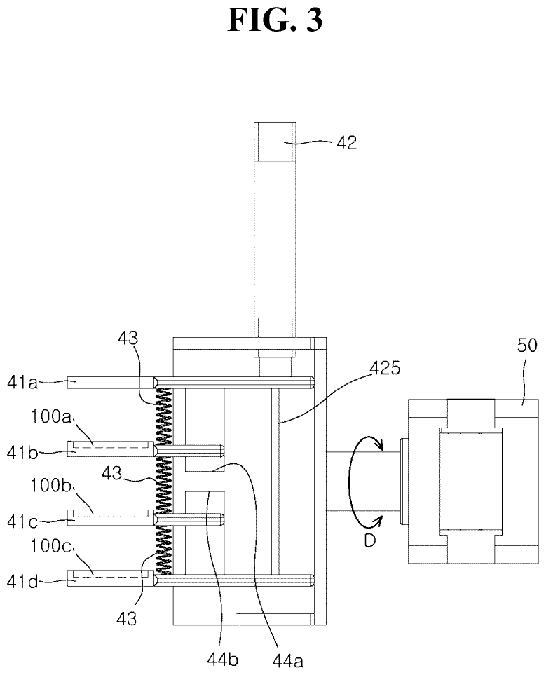

The gripper (40) comprises a plurality of receiving parts (41b to 41d) configured to accommodate the objects and an actuator (42) capable of moving the plurality of receiving parts (41b to 41d) closer to or further away from each other. The gripper (40) is rotatable in direction D (see FIG. 3) by a driving means (45).

The support part (41a) provided at the top of the gripper (40) does not accommodate an object. The receiving parts (41b to 41d) are formed with grooves where the objects (100a to 100c; see FIG. 3) can be seated. As shown in FIG. 3, the support part (41a) and the receiving parts (41b to 41d) are connected vertically to each other by elastic members (43) such as spring and the like.

The actuator (42) can drive the support part (41a) and the lowermost receiving part (41d) to move closer to each other or drive them to move further away from each other. Driving force may be transmitted in both directions, or actual driving force may be transmitted only in the direction of moving closer, and when moving in the direction of moving further away, the driving force may be removed so that the support part (41a) and each receiving part (41b to 41d) return to their original positions by the restoring force of the elastic members (43).

When the support part (41a) and the receiving part (41d) are driven in such a manner, the receiving part (41b) connected to the support part (41a) by an elastic member (43) and the receiving part (41c) connected to the receiving part (41d) by an elastic member (43) move in conjunction with the movement of the support part (41a) and the receiving part (41d), respectively. That is, when the actuator (42) drives the support part (41a) and the receiving part (41d) in a direction closer to each other, the receiving part (41b) moves downward (relative to the orientation in FIG. 3) along with the support part (41a), and the receiving part (41c) moves upward along with the receiving part (41d). The receiving parts (41b) and (41c) move until they are caught by stopper (44a) and stopper (44b), respectively, and in that state, the objects (100a to 100c) accommodated in the receiving parts are in a predetermined maximum close state with each other.

The operation of the inspection system according to the present disclosure will now be described.

A plurality of objects (not shown) are placed on the conveyor belt (14) of the supply unit (10), and as the conveyor belt (14) proceeds in direction A by the operation of the motor (12), the objects also move in direction A. When an object comes between the load transfer (20) and the pusher (30), the driving means of the pusher (30) operates, and then the push member (32) protrudes to move the object into the storage part (21a) of the load transfer (20). During this transfer, the conveyor belt (14) may be temporarily stopped, or if the operating speed of the push member (32) is sufficiently fast, it may operate continuously without stopping the conveyor belt (14).

After the first object is stored in the storage part (21a), the height of the load transfer (20) is adjusted so that the next storage part (21b) can be aligned to receive the next object. The height of the load transfer (20) is adjusted by a separate driving means (not shown). When the height of the storage part (21b) is adjusted, a subsequent object supplied by the conveyor belt (14) is moved into and stored in the storage part (21b) by the operation of the pusher (30), and through the aforementioned height adjustment process, the next object can be stored in the storage part (21c).

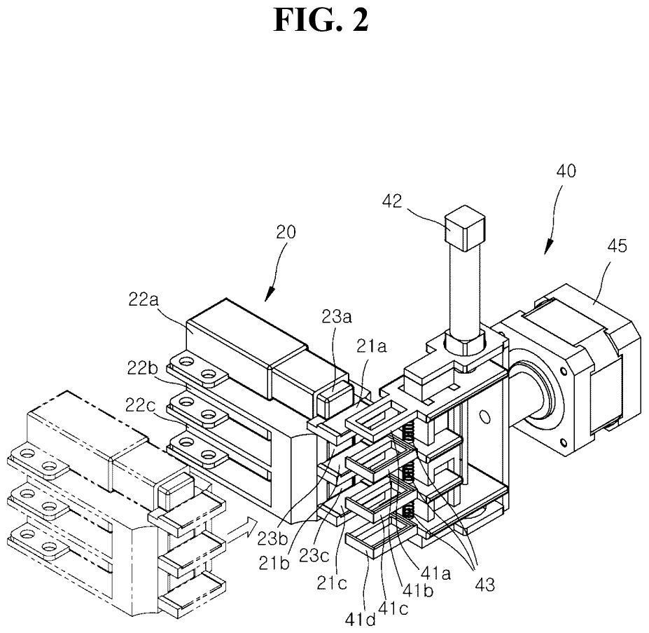

Once the objects are stored in the plurality of storage parts through the above process, the load transfer (20) moves toward the gripper (40) as shown in FIG. 2. The load transfer (20) indicated by the dotted line in FIG. 2 is the state before movement, and it moves to the position indicated by the solid line by the operation of a separate driving means (not shown). After the movement, the storage parts (21a to 21c) are aligned so that the objects can be moved to the receiving parts (41b to 41d).

Once alignment is completed, the transfer units (22a to 22c) provided for each storage part (21a to 21c) drive the push members (23a to 23c) to move the objects stored in the storage parts (21a to 21c) to the receiving parts (41b to 41d) of the gripper (40). The entrance of the receiving parts (41b to 41d) has no lip so that the object can pass through, while the other three sides of the receiving parts (41b to 41d) are formed with lips to prevent the accommodated object from dislodging. The transfer units (22a to 22c) may be operated simultaneously or separately with a time delay.

FIG. 3 shows a side view of the gripper (40) in a state where the objects (100a to 100c) are received in the receiving parts (41b to 41d). In the state of FIG. 3, operating the actuator (42) moves the support part (41a) and the receiving part (41d) in a direction closer to each other along the axis (425). Consequently, the receiving part (41b) connected to the support part (41a) by the elastic member (43) and the receiving part (41c) connected to the receiving part (41d) by the elastic member (43) also move in a direction closer to each other. The receiving parts (41b) and (41c) move until their movement is restricted by the stoppers (44a, 44b), and in that state, the objects (100a to 100c) are arranged in a maximum close state with a predetermined spacing.

In such an state, the gripper (40) is rotated in direction D by the driving means (45), while X-ray imaging is performed to acquire a CT image for internal defect inspection.

According to the present disclosure, an effect is provided in which a plurality of continuously supplied objects can be inspected quickly and all at once.

Although the present disclosure has been described above with reference to the accompanying drawings, the scope of the rights of the present disclosure is determined by the following claims and should not be interpreted as being limited to the aforementioned embodiments and/or drawings. It should be clearly understood that improvements, changes, and modifications of the present disclosure described in the claims that are obvious to those skilled in the art are also included in the scope of the rights of the present disclosure.

What is claimed is:

1. An inspection system for an object, comprising:
a supply unit for continuously supplying objects;
a load transfer;
a pusher for transferring the object from the supply unit to the load transfer; and
a gripper for receiving the object from the load transfer,
wherein the load transfer comprises a plurality of storage parts and a transfer unit for delivering objects to the gripper, and
wherein the gripper comprises a plurality of receiving parts and an actuator for moving the receiving parts closer to or further away from each other.

2. The inspection system of claim 1, wherein the load transfer is movable within a predetermined range to receive objects from the pusher.

3. The inspection system of claim 1, wherein an elastic member is provided between the plurality of receiving parts.

4. A method for inspecting an object using the inspection system of claim 1, comprising:
a step of pushing objects into the storage parts of the load transfer using the pusher;
a step of moving objects from the storage parts to receiving parts of the gripper;
a step of driving the actuator to move the receiving parts closer to each other; and
a step of acquiring CT images by performing X-ray imaging while rotating the gripper.
